(19) United States
(12) Patent Application Publication
(10) Pub. No.: US 2010/0232507 A1
(43) Pub. Date: Sep. 16, 2010

(54) METHOD AND APPARATUS FOR ENCODING AND DECODING THE COMPENSATED ILLUMINATION CHANGE

(76) Inventors: Suk-Hee Cho, Daejeon-city (KR); Hyoung-Jin Kwon, Cheongju-city (KR); Namho Hur, Daejeon-city (KR); Jin-Woong Kim, Daejeon-city (KR); Soo-in Lee, Daejeon-city (KR); Yung-Lyul Lee, Seoul (KR); Jae-Ho Hur, Gyeonggi-do (KR); Dong-Gyu Sim, Seoul (KR)

Correspondence Address: LADAS & PARRY LLP, 224 SOUTH MICHIGAN AVENUE, SUITE 1600, CHICAGO, IL, 60604, US

(21) Appl. No.: 12/293,577

(22) PCT Filed: Mar. 22, 2007
(86) PCT No.: PCT/KR2007/001413

§ 371 Date: Oct. 31, 2008

(30) Foreign Application Priority Data
Mar. 22, 2006 (KR) 10-2006-0026175
Jul. 5, 2006 (KR) 10-2006-0062999
Mar. 22, 2007 (KR) 10-2007-0028225

(51) Int. Cl. H04N 7/26

(52) U.S. Cl. 375/240.16; 375/E07.123

(57) ABSTRACT

A method of and apparatus for encoding and decoding a signal by illumination change compensated motion estimation are provided. The apparatus for encoding a signal by illumination change compensated motion estimation includes: an illumination change compensation unit performing compensation for an illumination change by performing a differential calculation between each pixel value of a current block and the means pixel value of a reference block indicated by a motion vector of the current block and the mean pixel value of the reference block; a residual signals generation unit generating residual signals based on the blocks in which illumination change compensation is performed; and an illumination changed amount prediction unit performing differential pulse code modulation (DPCM) based on the illumination change amount prediction value by reflecting the closeness between neighboring blocks in which illumination change occurs.

### TECHNICAL FIELD

The present invention relates to a method and apparatus for encoding and decoding a signal by illumination change compensated motion estimation, and more particularly, to a method and apparatus for efficiently encoding and decoding an image in which illumination changes, by compensating for illumination change in processes of motion estimation and motion compensation.

### BACKGROUND ART

According to conventional technology, ITU Telecommunication Standardization Sector (ITU-T) and ISO/IEC announced that the H.26x series and moving picture experts group (MPEG)-x series are to be used in processes to improve encoding efficiency of a video. Also, in 2003, H.264/MPEG-4 advanced video coding (AVC) was completed, thereby allowing a large amount of bits to be reduced.

Along with the development of the video encoding standards, many studies on block matching motion estimation (BMME) have been carried out. In most of the BMME methods, the sum of absolute differences (SAD) between a block of a current frame and candidate blocks of reference frames is obtained so that the position of a candidate block of the reference frame showing a least SAD can be determined as a motion vector of the block of the current frame.

Then, differential signals (residuals) between the candidate block and the current frame block undergo discrete cosine transformation (DCT) and quantization, thereby performing variable length coding with the motion vector.

Here, since a motion vector is obtained by removing temporal redundancy between a current frame and a reference frame, encoding efficiency increases substantially. Also, by using weighted prediction and thereby encoding a video adaptively according to global illumination change in the image, H.264/MPEG-4 AVC increases compression efficiency.

However, the weighted prediction of H.264 cannot perform encoding adaptively according to local illumination changes. For example, when a local illumination change occurs in an image, or in the case of multi-view video coding in which an image obtained from many cameras is encoded, it is highly probable that local illumination changes as well as global illumination changes occur in the obtained images. Accordingly, this limits enhancing of encoding efficiency by the conventional weighted prediction of H.264/MPEG-4 AVC.

### DETAILED DESCRIPTION OF THE INVENTION

### Technical Problem

The present invention provides a method and apparatus for efficiently encoding and decoding a video in which illumination changes, by compensating for illumination change in processes of motion estimation and motion compensation.

### Technical Solution

The present invention provides a method and apparatus for efficiently encoding and decoding a video in which illumination changes, by compensating for illumination change in processes of motion estimation and motion compensation.

According to an aspect of the present invention, there is provided an apparatus for encoding a signal by illumination change compensated motion estimation including: an illumination change compensation unit performing compensation for an illumination change by performing a differential calculation between each pixel value of a current block and a mean pixel value of the current block, and a differential calculation between each pixel value of a reference block indicated by a motion vector of the current block and a mean pixel value of the reference block; residual signals generation unit generating residual signals based on the blocks in which illumination change compensation is performed; and an illumination change amount prediction unit performing differential pulse code modulation (DPCM) based on an illumination change amount prediction value by reflecting the closeness between neighboring blocks in which illumination change occurs.

### ADVANTAGEOUS EFFECTS

According to the present invention, a video can be efficiently encoded and decoded, by using motion estimation and motion compensation by compensating for illumination change. That is, when a local or global illumination change between images occurs, an image is adaptively encoded, thereby increasing compression efficiency in relation to the occurrence of the illumination changes.

Also, by using the spatial closeness of areas in which illumination changes occur, the amount of illumination change is compressed, thereby allowing bits that are required to reflect the amount of illumination change to be further reduced.

### DESCRIPTION OF THE DRAWINGS

FIG. 1 is a diagram illustrating an apparatus for encoding a signal by illumination change compensated motion estimation according to an embodiment of the present invention;

FIG. 2 is a diagram illustrating neighboring macroblocks that are used to predict an illumination change amount of a current block according to an embodiment of the present invention;

FIG. 3 is a diagram illustrating an encoding apparatus which performs illumination change compensated motion estimation in an inter mode in which motion detection is performed according to an embodiment of the present invention;

FIG. 4 is a diagram illustrating an apparatus for encoding a signal by illumination change compensated motion estimation according to an embodiment of the present invention;

FIG. 5 is a diagram illustrating a structure of an apparatus for decoding a signal by illumination change compensated motion estimation according to an embodiment of the present invention;

FIG. 6 is a diagram illustrating an apparatus for decoding a signal by illumination change compensated motion estimation according to an embodiment of the present invention;

FIGS. 7A and 7B illustrate slice data syntax according to an embodiment of the present invention;

FIGS. 8A and 8B illustrate macroblock layer syntax according to an embodiment of the present invention;

FIGS. 9A and 9B illustrate mb_pred(mb_type) syntax according to an embodiment of the present invention;

FIG. 10 is a flowchart illustrating a method of encoding a signal by illumination change compensated motion estimation according to an embodiment of the present invention;

FIG. 11 is a flowchart illustrating a method of encoding a signal by illumination change compensated motion estimation in an inter mode and in a direct mode according to an embodiment of the present invention;

FIG. 12 is a table illustrating video sequences used in experimental embodiments of the present invention;

FIG. 13 is a table illustrating experimental conditions for experiments using images illustrated in FIG. 12; and

FIGS. 14A through 14F illustrate the effects of employing a method of encoding and decoding a signal by illumination compensated motion estimation according to an embodiment of the present invention.

### BEST MODE

### Mode of the Invention

According to an aspect of the present invention, there is provided an apparatus for encoding a signal by illumination change compensated motion estimation including: an illumination change compensation unit performing compensation for an illumination change by performing a differential calculation between each pixel value of a current block and the mean pixel value of the current block, and a differential calculation between each pixel value of a reference block indicated by a motion vector of the current block and the mean pixel value of the reference block; residual signals generation unit generating residual signals by performing a differential calculation between the current block in which illumination change compensation is performed by the illumination change compensation unit, and the reference block corresponding to the motion vector and in which illumination change compensation is performed; and an illumination change amount prediction unit, wherein the amount of illumination change is the difference between the mean pixel value of the current block and the mean pixel value of the reference block, setting the amount of illumination change of the illumination compensated neighboring blocks as an illumination change amount prediction value of the current block, and performing differential pulse code modulation (DPCM) based on the illumination change amount and illumination change amount prediction value of the current block.

According to an aspect of the present invention, there is provided an apparatus for encoding a signal through illumination change compensated motion estimation in inter mode for performing motion detection including: an illumination change prediction unit setting a motion vector based on a value (NewSAD) which is the sum of absolute differences, each of which is the difference obtained by subtracting the amount of illumination change which is the difference between the mean pixel value of a current block and the mean pixel value of a reference block from the difference between a pixel value of the current block and a pixel value of the reference block; an illumination change compensation unit performing compensation for illumination change by performing a differential calculation between each pixel value of a current block from the mean pixel value of the current block, and subtracting each pixel value of a reference block indicated by a motion vector of the current block from the mean pixel value of the reference block; and an illumination change amount prediction unit setting the illumination change amount of the illumination-compensated neighboring blocks as the illumination change amount prediction value of the current block, and performing DPCM based on the illumination change amount and illumination change amount prediction value of the current block.

According to an aspect of the present invention, there is provided an apparatus for encoding a signal through illumination change compensated motion estimation in direct mode in which motion detection is not performed, including: an illumination change compensation unit performing compensation for illumination change performing a differential calculation between each pixel value of a current block and the mean pixel value of the current block, and a differential calculation between each pixel value of a reference block indicated by a motion vector obtained by a temporal or spatial prediction method, and the mean pixel value of the reference block; and an illumination change amount prediction unit setting the illumination change amount of the illumination-compensated neighboring blocks, as the illumination change amount prediction value of the current block, and performing DPCM based on the illumination change amount and illumination change amount prediction value of the current block, wherein the amount of illumination change is the difference between the mean pixel value of the current block and the mean pixel value of the reference block.

According to another aspect of the present invention, there is provided a method of encoding a signal through illumination change compensated motion estimation including: performing compensation for illumination change by performing a differential calculation between each pixel value of a current block and the mean pixel value of the current block, and a differential calculation between each pixel value of a reference block indicated by a motion vector of the current block and the mean pixel value of the reference block; generating residual signals by performing a differential calculation between the illumination-compensated current block and the illumination-compensated reference block corresponding to the motion vector; and setting the amount of illumination change of the illumination-compensated neighboring block as an illumination change amount prediction value of the current block, and performing differential pulse code modulation (DPCM), based on the illumination change amount and illumination change amount prediction value of the current block, wherein the amount of illumination change is the difference between the mean pixel value of the current block and the mean pixel value of the reference block.

According to another aspect of the present invention, there is provided a method of encoding a signal through illumination change compensated motion estimation in direct mode in which motion detection is not performed, the method including: performing compensation for illumination change by performing a differential calculation between each pixel value of a current block and the mean pixel value of the current block, and a differential calculation between each pixel value of a reference block indicated by a motion vector obtained by a temporal or spatial prediction method, and the mean pixel value of the reference block; and setting the amount of illumination change of the illumination-compensated neighboring block as an illumination change amount prediction value of the current block, and performing differential pulse code modulation (DPCM), based on the illumination change amount and illumination change amount prediction value of the current block, wherein the amount of illumination change is the difference between the mean pixel value of the current block and the mean pixel value of the reference block.

### DETAILED DESCRIPTION OF THE INVENTION

The present invention will now be described more fully with reference to the accompanying drawings, in which exemplary embodiments of the invention are shown. In the drawings, whenever the same element reappears in subsequent drawings, it is denoted by the same reference numeral. In the explanation of the present invention, if it is determined that detailed explanation of a conventional technology related to the present invention may confuse the scope of the present invention, the description will be omitted.

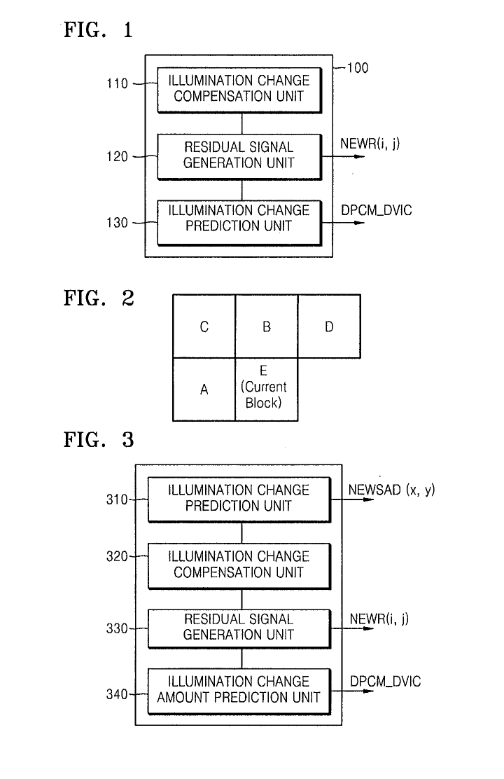

FIG. 1 is a diagram illustrating an apparatus 100 for encoding a signal by illumination change compensated motion estimation according to an embodiment of the present invention.

The apparatus 100 for encoding a signal by illumination change compensated motion estimation includes an illumination change compensation unit 110, a residual signals generation unit 120 and an illumination change amount prediction unit 130.

In the current embodiment, when an illumination change occurs globally or locally, motion prediction encoding is performed by compensating for the illumination change. A method of encoding a signal by illumination change compensated motion estimation has two modes, an inter block mode in which motion detection is performed, and a direct prediction mode in which motion detection is not performed.

First, a motion vector is obtained in a current macroblock in which an illumination change occurs. The motion vector can be obtained in different ways according to whether the operation mode is the inter block mode in which motion detection is performed, or the direct prediction mode in which motion detection is not performed. The inter mode is applied to a P slice or a B slice, and the direct mode is applied to a B slice. A method of obtaining a motion vector in each mode will now be explained.

(1) Inter Mode

In inter mode, in which motion detection is performed, a new sum of absolute differences (NewSAD) value of each of candidate blocks corresponding to a current block is obtained. The NewSAD value is the sum of absolute differences between first values and second values, in which the first values are the differences between the pixel values of the current block and the pixel values of a reference block, and the second values are illumination change amounts. Then, a motion vector is obtained from a reference block corresponding to a NewSAD value having a minimum value from among the NewSAD values. In this case, the amount of illumination change, which is an illumination change occurring in each macroblock, is obtained by performing a differential calculation between a mean pixel value of the reference block (Refer to equation 2) and a mean pixel value of the current block (Refer to equation 3).

The NewSAD defined in equation 1 below indicates the sum of absolute differences reflecting illumination change compensation of the present invention in the sum of absolute values (SAD) of conventional technology:

$$NewSAD ( x , y ) = {\sum }_{i = m}^{m + S - 1} {\sum }_{j = n}^{n + T - 1} \vert \{ f ( i , j ) - {M}_{cur} ( m , n ) \} - \{ r ( i + x , j + y ) - {M}_{ref} ( m + x , n + y ) \} \vert \qquad ( 1 )$$

Here, f(i,j) denotes a pixel value at coordinates (i,j) of a current block, r(i+x,j+y) denotes a pixel value at coordinates (i+x,j+y) of a reference block, (x,y) denotes a motion vector, Mcur(m,n) denotes the mean pixel value of the current block, Mref(m+x,n+y) denotes the mean pixel value of the reference block, (m,n) denotes the position of a top left pixel of the current block, and S and T denote the sizes of blocks, respectively, which are used in block matching.

Also, Mcur(m,n) denoting the mean pixel value of the current block and Mref(p,q) denoting the mean pixel value of the reference block can be obtained from the following equations 2 and 3, respectively:

$$\begin{matrix}{M}_{cur} ( m , n ) = \frac{1}{S \times T} {\sum }_{i = m}^{m + S - 1} {\sum }_{j = n}^{n + T - 1} f ( i , j ) & ( 2 ) \\ {M}_{ref} ( p , q ) = \frac{1}{S \times T} {\sum }_{i = p}^{p + S - 1} {\sum }_{j = q}^{q + T - 1} r ( i , j ) & ( 3 )\end{matrix}$$

Here, Mcur(m,n) denotes the mean pixel value of the current block, Mref(p,q) denotes the mean pixel value of the reference block, f(i,j) denotes a pixel value at coordinates (i,j) of the current block, r(i,j) denotes a pixel value at coordinates (i,j) of the reference block, S and T denote the sizes of blocks, respectively, which are used in block matching, (m,n) denotes the position of the top left pixel of the current block, and (p,q) denotes the position of the top left pixel of the reference block.

(2) Direct Mode

In the case of the direct mode in which motion detection is not performed, a motion vector and a reference frame block indicated by the motion vector are obtained by a direct prediction mode method. The direct prediction mode method can be one of a spatial direct prediction mode and a temporal direct prediction mode.

In the spatial direct prediction mode method, the motion vector of a current block is determined by using the motion vectors of blocks neighboring the current block. In the temporal direct prediction mode method, the motion vector of a block at the same position in a frame that exists after a current time in the time domain, as the position of the current block in a current frame, is scaled by using the distance between the frames, thereby determining the motion vector of the current block.

*Illumination Change Compensation

The illumination change compensation unit 110 performs illumination change compensation, by performing differential calculations between each pixel value of the current block and the mean pixel value (Mcur) of equation 2 of the current block, and between each pixel value of the reference block indicated by the motion vector and the mean pixel value (Mref) of equation 3 of the reference block, by using the motion vector and reference block obtained in the inter mode or direct mode.

The residual signals generation unit 120 generates residual signals by performing a differential calculation between the current block in which illumination change compensation is performed in the illumination change compensation unit 110, and the reference block in which illumination change compensation corresponding to the motion vector is performed. That is, by equation 4 below, motion compensation in which illumination change is reflected is performed. Then, the generated residual signals become encoded residual signals (NewR′) by DCT and quantization in a residual signals processing unit (not shown). Each residual signal is calculated according to equation 4 below:

NewR(i,j)={f(i,j)−Mcur(m,n)}−{r(i+x′,j+y′)−Mref(m+x′,n+y′)} (4)

Here, NewR(i,j) denotes a residual signal at coordinates (i,j), f(i,j) denotes a pixel value at coordinates (i,j) of the current block, r(i+x′,j+y′) denotes a pixel value of the reference block corresponding to the motion vector, (x′,y′) denotes a motion vector, Mcur(m,n) denotes the mean pixel value of the current block, Mref(m+x,n+y) denotes the mean pixel value of the reference block, and (m,n) denotes the position of a top left pixel of the current block.

*Prediction of Amount of Illumination Change

In general, an area in which illumination change occurs is wider than an area occupied by one macroblock. Accordingly, the amount of illumination change in a current macroblock is closely related to the amount of illumination change in a neighboring macroblock. In order to reduce the amount of bits required to reflect the amount of illumination change, differential pulse code modulation (DPCM) between the illumination change amount of a current block and a predicted value of the amount of illumination change (predDVIC) calculated from a neighboring block is performed and the DPCM modulated result is output in the form of a bitstream.

The illumination change amount prediction unit 130 sets the illumination change amount between the current block and a neighboring block in which illumination change compensation has already been performed in the illumination change compensation unit 110, from among blocks neighboring the current block, as an illumination change amount prediction value of the current block, and performs DPCM based on the illumination change amount of the current block and the illumination change amount prediction value. In this way, residual signals can be encoded using less bits.

FIG. 2 is a diagram illustrating neighboring macroblocks that are used to predict an illumination change amount of a current block according to an embodiment of the present invention.

Referring to FIG. 2, the illumination change amount prediction unit 130 sets the illumination change amount of a block in which illumination change compensation has already been performed, from among blocks A, B, C, and D, which are neighboring a current block E, as an illumination change amount prediction value of the current block E, and uses the prediction value in prediction of the amount of illumination change.

More specifically, the prediction value of the amount of illumination change (predDVIC) is obtained according to the following procedure.

Step 1) If the block A is positioned to the left of current block E in FIG. 2 has the same reference frame number as the reference frame number of the current block and illumination change compensation for the block A is performed, the illumination change amount of the block A is determined as an illumination change amount prediction value and the calculation is finished. Or else, the next step is performed.

Step 2) If the block B is positioned above current block E in FIG. 2 has the same reference frame number as the reference frame number of the current block and illumination change compensation for the block B is performed, the illumination change amount of the block B is determined as an illumination change amount prediction value and the calculation is finished. Or else, the next step is performed.

Step 3) If the block C is positioned above and to the left of current block E in FIG. 2 has the same reference frame number as the reference frame number of the current block and illumination change compensation for the block C is performed, the illumination change amount of the block C is determined as an illumination change amount prediction value and the calculation is finished. Or else, the next step is performed.

Step 4) If the block D is positioned above and to the right of current block E in FIG. 2 has the same reference frame number as the reference frame number of the current block and illumination change compensation for the block D is performed, the illumination change amount of the block D is determined as an illumination change amount prediction value and the calculation is finished. Or else, the next step is performed.

Step 5) If illumination change compensations for the block A positioned above the current illumination change compensation block, the block B positioned to the left of the current illumination change compensation block, and the block C positioned above and to the right of the current illumination change compensation block are performed, the illumination change amounts of the three blocks are mean-value-filtered and then, the result is determined as an illumination change prediction value, and the calculation is finished. Or else, the next step is performed.

Step 6) An illumination change prediction value is determined as 0.

Based on the illumination change amount prediction value obtained by performing the above procedure and the illumination change amount of the current block, DPCM is performed, and entropy encoding is performed. The procedure is performed in a decoder for decoding the illumination change amount of the current block in the same manner.

FIG. 3 is a diagram illustrating an encoding apparatus which performs illumination change compensated motion estimation in the inter mode in which motion detection is performed according to an embodiment of the present invention.

The apparatus for encoding a signal by illumination change compensated motion estimation includes an illumination change prediction unit 310, an illumination change compensation unit 320, a residual signals generation unit 330, and an illumination change amount prediction unit 340.

In the inter mode, which is described above, the illumination change prediction unit 310 obtains a motion vector and a reference frame by using equations 1 through 3 according to a method of obtaining a NewSAD.

The illumination change compensation unit 320, the residual signals generation unit 330, and the illumination change amount prediction unit 340 perform practically the same functions as are performed by the respectively corresponding elements, illustrated in FIG. 1. Accordingly, those elements described above with reference to FIG. 1 can be referred to.

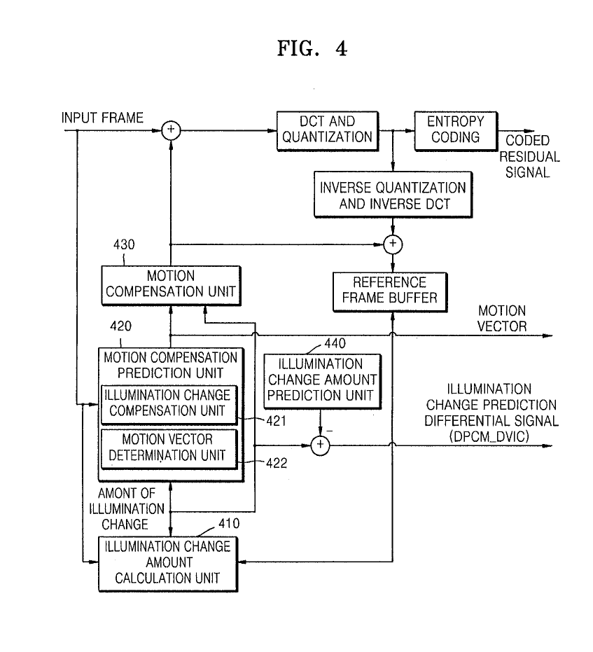

FIG. 4 is a diagram illustrating an apparatus for encoding a signal by illumination change compensated motion estimation according to an embodiment of the present invention. An illumination change amount calculation unit 410 obtains the amount of illumination change, by performing a differential calculation between the mean pixel value of a current block and the mean pixel value of a reference block (Refer to equations 2 and 3).

In the case of the inter mode in which motion detection is used, a motion estimation unit 420 determines a position having a smallest NewSAD value in a motion vector determination unit 422 as a motion vector, by using the amount of illumination change calculated in the illumination change amount calculation unit 410. Also, in an illumination change compensation unit 421, illumination change is compensated for, by performing a differential calculation of each of the mean pixel value of the current block, and the mean pixel value of the reference block.

In the case of the direct mode in which motion detection is not used, the motion vector determination unit 422 determines a reference block, by using a final motion vector which is determined by a direct prediction mode calculation method. Then, the illumination change compensation unit 421 performs illumination change compensation, by performing a differential calculation between a pixel value of a current block and the mean pixel value of the current block, and a differential calculation between a pixel value of a reference block indicated by a motion vector of the current block and the mean pixel value of the reference block.

A motion compensation unit 430 performs motion compensation. Wherein the motion compensation is concurrently performed with the illumination change compensation according to equation 4, by using the mean pixel value of the current block, the mean pixel value of the reference block, and the motion vector, calculated by the illumination change amount calculation unit 410, and the motion estimation unit 420.

Then, by using spatial correlation of the amount of illumination change, the illumination change amount prediction unit 440 performs DPCM of the amount of illumination change of the current block in relation to the prediction value (predDVIC) of the amount of illumination change calculated in neighboring blocks, and puts the result into a bitstream.

An encoded residual signal calculated in the above process and the prediction-encoded amount of illumination change are entropy-encoded and the encoding process is finished.

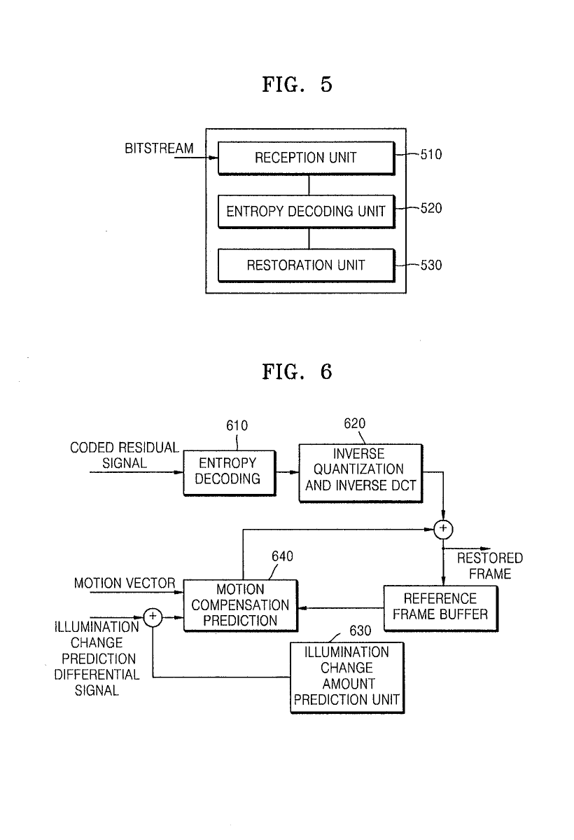

FIG. 5 is a diagram illustrating a structure of an apparatus for decoding a signal by illumination change compensated motion estimation according to an embodiment of the present invention.

The apparatus for decoding a signal by illumination change compensated motion estimation includes a reception unit 510, an entropy decoding unit 520, and a reconstruction unit 530.

The reception unit 510 receives a bitstream transmitted by an apparatus for encoding a signal by illumination change compensated motion estimation. The bitstream includes illumination change indication information indicating whether or not illumination change compensation has been performed, for example, indication information, such as mb_ic_flag. The illumination change indication according to the current embodiment may have an indication information format or metadata format, and unless a decoder cannot recognize the format, there is no limit to the format of the information. Also, the bitstream further includes an illumination change amount prediction value, which is DPCM modulated and encoded based on the illumination change amount of a neighboring block, in which illumination change has already been performed, and the illumination change amount of a current block, and encoded residual signals.

If mb_ic_flag is 0, it is determined that illumination compensation is not performed in the current macroblock, and a conventional decoding process is performed. If mb_ic_flat is 1, illumination change compensation is performed in the current macroblock and by using a differential modulation value of the amount of illumination change (DVIC), reconstruction is performed.

In the entropy decoding unit 520, if illumination indication information indicates that illumination change is performed in the encoder side, the encoded residual signals (NewR′), which are received by the reception unit 510, is reconstructed to the residual signals (NewR″) by inverse quantization and inverse DCT.

The reconstruction unit 530 restores a block, based on the residual signals restored by the entropy decoding unit 520, the encoded illumination change prediction differential signal (DPCM_DVIC) and the motion vector. The pixel value of the block to be decoded can be obtained according to equation 5 below:

f′(i,j)={NewR″(i,j)+r(i+x′,j+y′)}+{Mcur(m.n)−Mref(m+x′,n+y′)} (5)

Here, f′(i,j) denotes a pixel value at coordinates (i,j) of a current block, r(i+x′,j+y′) denotes a pixel value at coordinates (i+x′,j+y′) of a reference block, Mcur(m,n) denotes the mean pixel value of the current block, Mref(m+x′,n+y′) denotes the mean pixel value of the reference block, and (x,y) denotes a motion vector.

FIG. 6 is a diagram illustrating an apparatus for decoding a signal by illumination change compensated motion estimation according to an embodiment of the present invention.

In a decoding process, residual signals (NewR′), which are encoded in an encoder, is restored to residual signals (NewR″) by an entropy decoding unit 610, and an inverse quantization and inverse DCT unit 620. For a method of obtaining each restored residual signal, equation 5 described above can be referred to.

In the same manner as in the apparatus for encoding a signal by illumination change compensated motion estimation, the amount of illumination change is decoded, by obtaining an illumination change amount prediction value in an illumination change differential value prediction unit 630, by using the amount of illumination change in a previous decoded block.

A motion compensation prediction unit 640 obtains the pixel value of a block that is currently desired to be decoded, based on equation 5, by using a motion vector, the restored residual signals (NewR″), and the amount of illumination change.

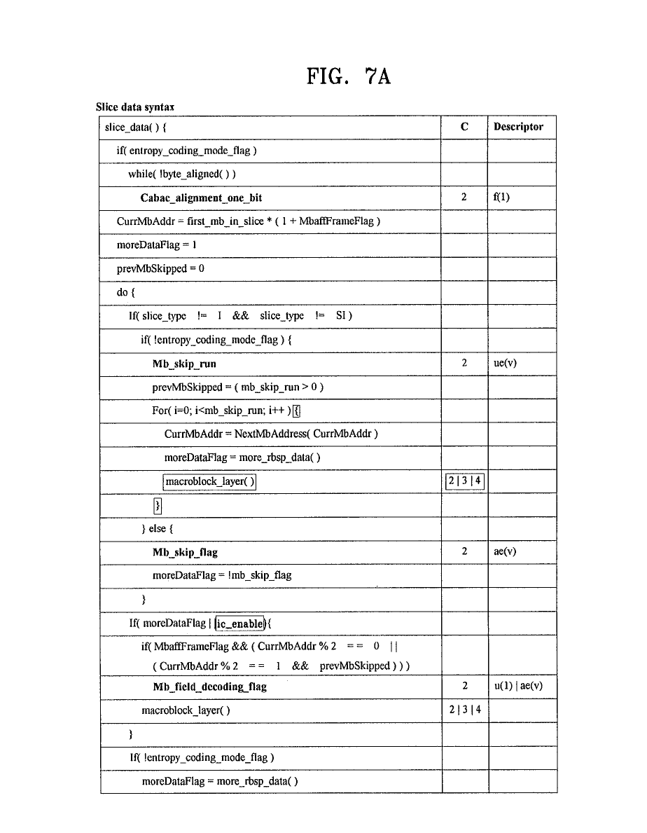

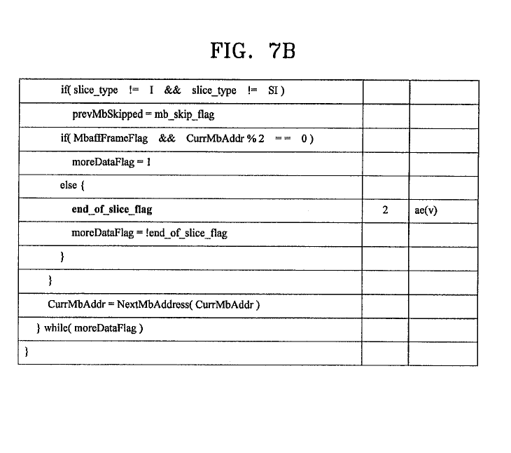

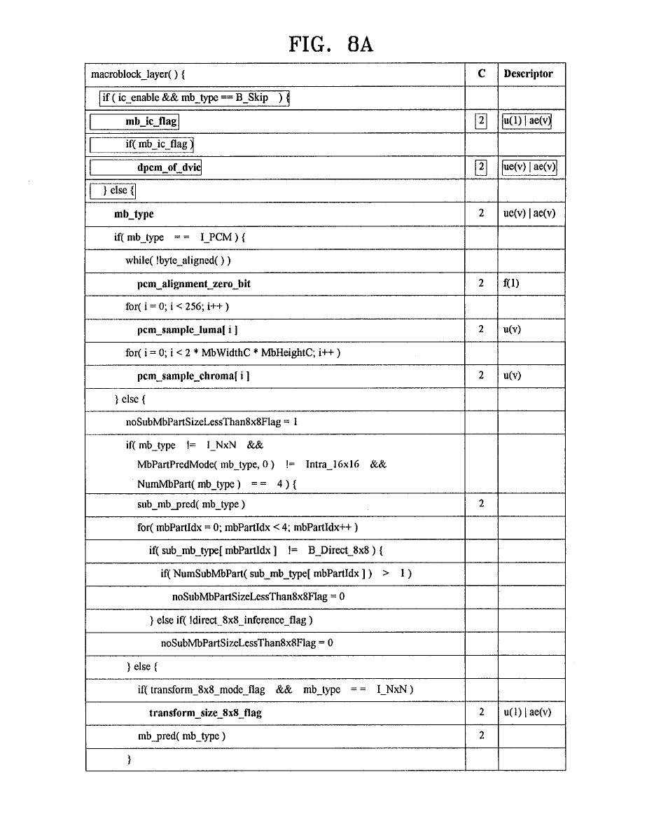

FIGS. 7A and 7B illustrate a slice data syntax according to an embodiment of the present invention.

The slice data syntax is a statement for entropy encoding data which is obtained in the process of encoding a macroblock. According to the current embodiment, in P_Skip mode, which is a skip mode of a P picture, mb_ic_flat and dpcm_of_divc information that is illumination change compensation information should be encoded. Accordingly, when if(Slice_type !=l && slice_type !=Sl) and if(!entropy_coding_mode_flag), a statement of macroblock_layer( ) is added so that mb_ic_flag and dpcm_of_divc information can be encoded.

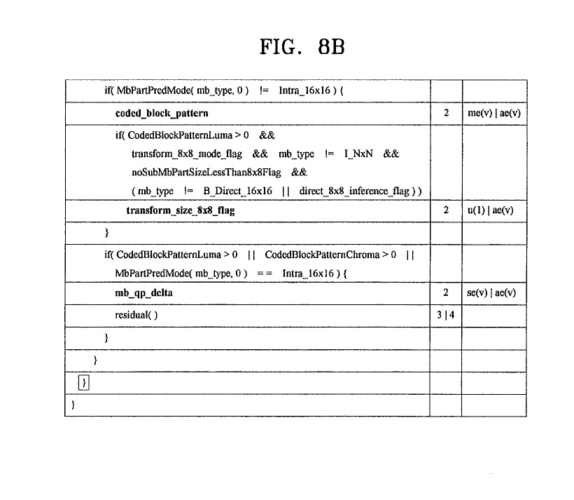

FIGS. 8A and 8B illustrate a macroblock layer syntax according to an embodiment of the present invention.

The macroblock_layer syntax is a statement for entropy encoding data which is obtained in the encoding process of each macroblock. According to the current embodiment, when if(ic_enable && mb_type==B_skip), a statement for encoding mb_ic_flag and dpcm_of_divc information that is illumination change compensation information is added.

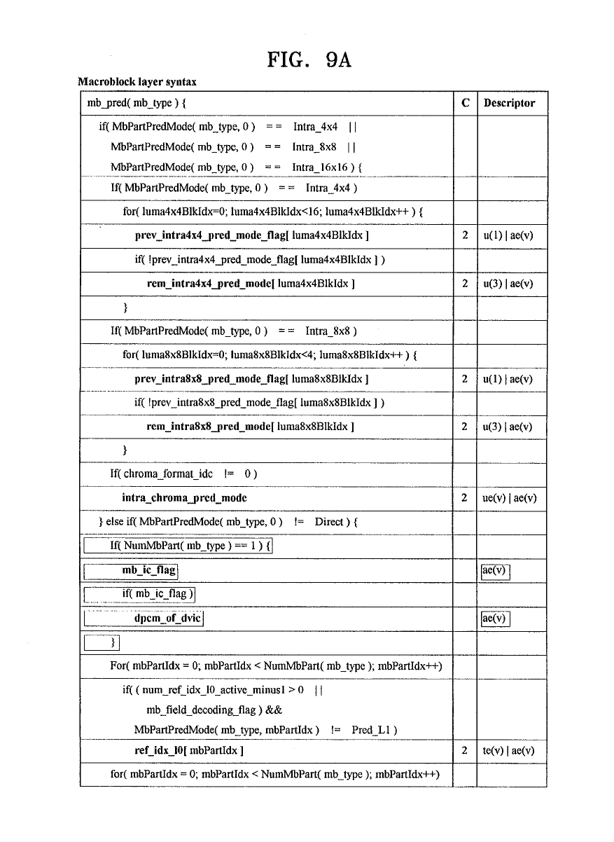

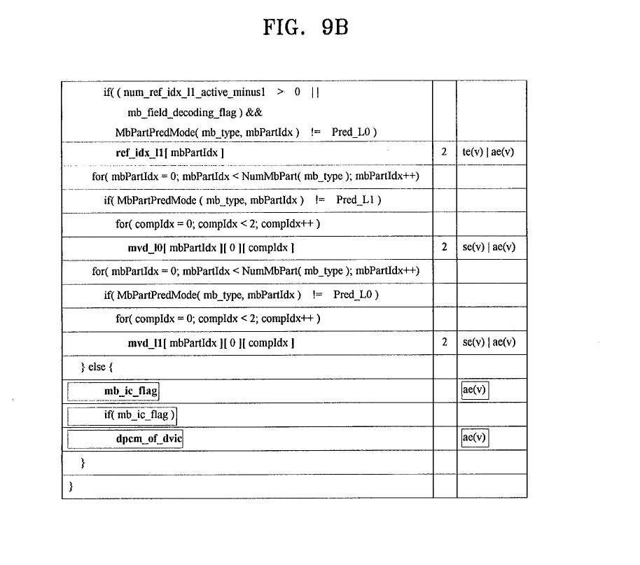

FIGS. 9A and 9B illustrate an mb_pred(mb_type) syntax according to an embodiment of the present invention.

The mb_pred(mb_type) syntax is a statement for entropy encoding data which is obtained in the process of encoding a macroblock in the intra mode, inter mode, and direct mode. According to the current embodiment, in the cases of the inter mode and direct mode, a statement for encoding mb_ic_flag and dpcm_of_divc information that is illumination change compensation information is added. The mb_ic_flag and dpcm_of_divc information added in the first half corresponds to the inter mode, and the mb_ic_flag and dpcm_of_divc information added in the second half corresponds to the direct mode.

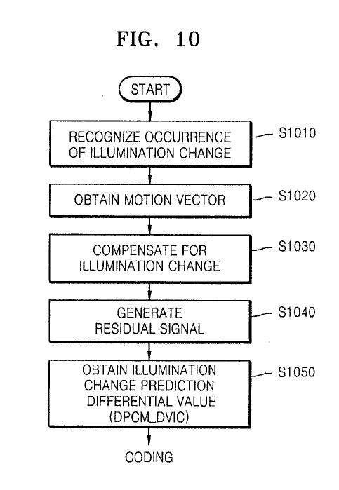

FIG. 10 is a flowchart illustrating a method of encoding a signal by illumination change compensated motion estimation according to an embodiment of the present invention.

First, when it is determined that an illumination change has occurred, a motion vector is obtained according to whether the prediction mode is the inter mode in which motion detection is performed, or the direct mode in which motion detection is not performed, in operations S1010 and S1020. Then, the illumination change is compensated for by performing a differential calculation between each pixel value of a current block and the mean pixel value of the current block, and a differential calculation between each pixel value of a reference block indicated by a motion vector of the current block and the mean pixel value of the reference block, in operation S1030.

Then, residual signals are generated by performing a differential calculation between the current block, in which illumination change compensation is performed, and the reference block corresponding to the motion vector, in which illumination change compensation is performed, in operation S1040.

Then, the amount of illumination change of the neighboring block, in which illumination change is performed, from among blocks neighboring the current block, is set as an illumination change amount prediction value of the current block, and an illumination change prediction differential signal (DPCM_DVIC), which is the amount of illumination change predicted by performing DPCM, based on the amount of illumination change of the current block, and the illumination change amount prediction value, is calculated in operation S1050.

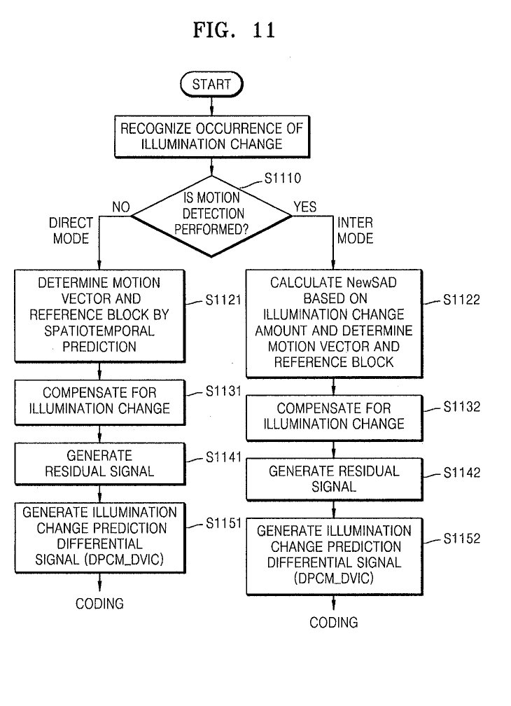

FIG. 11 is a flowchart illustrating a method of encoding a signal by illumination change compensated motion estimation in inter mode and in direct mode according to an embodiment of the present invention.

After it is determined that an illumination change has occurred, it is determined whether or not a current macroblock is in a mode in which motion detection is performed in operation S1110.

If the mode is the direct mode in which motion detection is not performed, a motion vector is obtained by using spatial prediction, and a reference block is determined in operation S1121. Then, the illumination change is compensated for in operation S1131, and residual signals are generated in operation S1141. Then, if the illumination change between the current block and a neighboring block has already been compensated for, DPCM is performed by using the compensation result, thereby obtaining and encoding an illumination change amount prediction value in operation S1151. For further explanation of each operation, the explanation on the elements corresponding to the operation, described above, can be referred to.

In the inter mode in which motion detection is performed, a NewSAD value is obtained based on the amount of illumination change, and based on the NewSAD value, a motion vector and a reference block are determined in operation S1122. Then, the illumination change is compensated for in operation S1132, and residual signals are generated in operation S1142. Then, if the illumination change between the current block and a neighboring block has already been compensated for, DPCM is performed by using the compensation result, thereby obtaining and encoding an illumination change amount prediction value in operation S1152. For further explanation of each operation, the explanation on the elements corresponding to the operation, described above, can be referred to.

FIG. 12 is a table illustrating video sequences used in experimental embodiments of the present invention.

Experiments involving the present invention were performed by using a joint scalable video model (JSVM) 3.5, which is a reference encoder of H.264/MPEG-4 AVC, and applied to a 16×16 block mode and a spatial direct mode. Also, the experiments were performed with multiple-view video sequences, and an encoder implemented based on a multiple-view encoding method suggested by ISO/IEC MPEG (hereinafter referred to as ‘MPEG’). Also, the present invention used images, which are currently used in multiple-view video coding standardization of the MPEG standard.

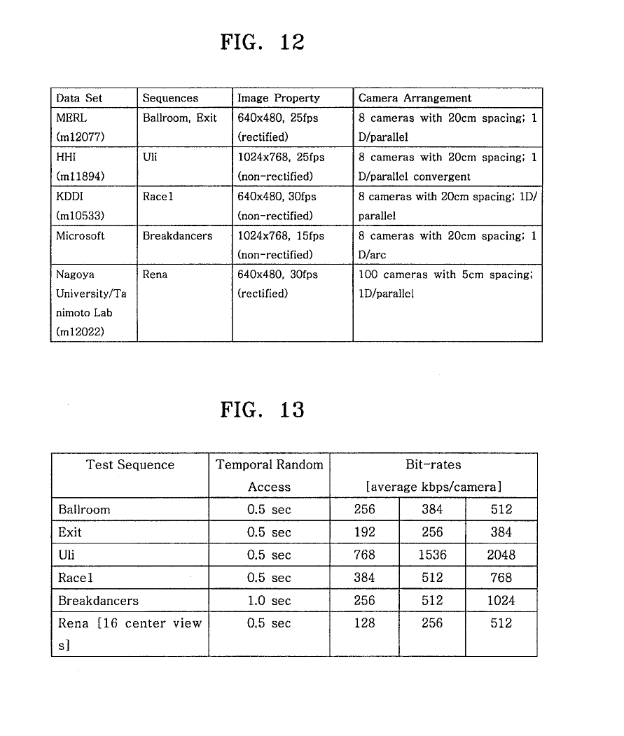

FIG. 13 is a table illustrating experimental conditions for experiments using the video sequences illustrated in FIG. 12.

In all experiments performed involving the present invention, a preset bitrate rate distortion optimization technology was employed. The proposed method according to the present invention is compared with the rate distortion (RD) result of a multiple-view video coding method using a hierarchical B structure currently suggested by the MPEG, and the RD result using a weighted prediction method.

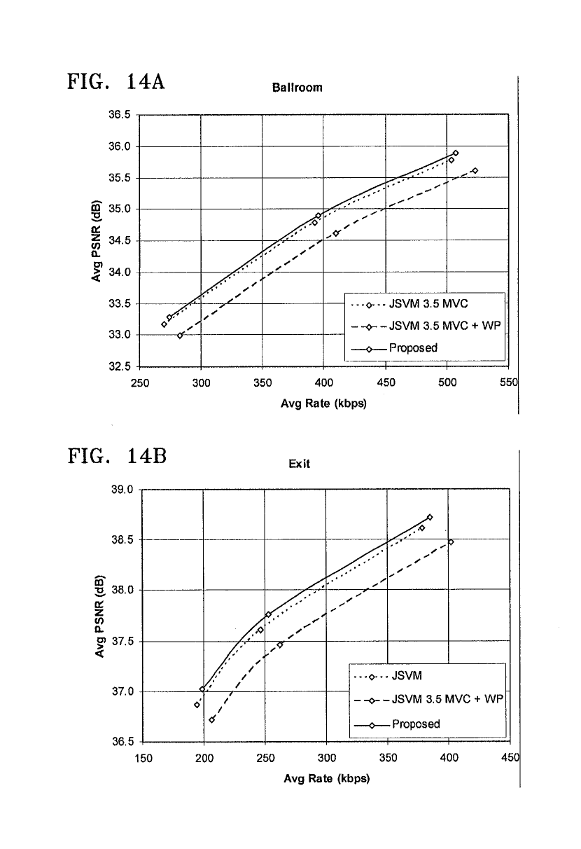

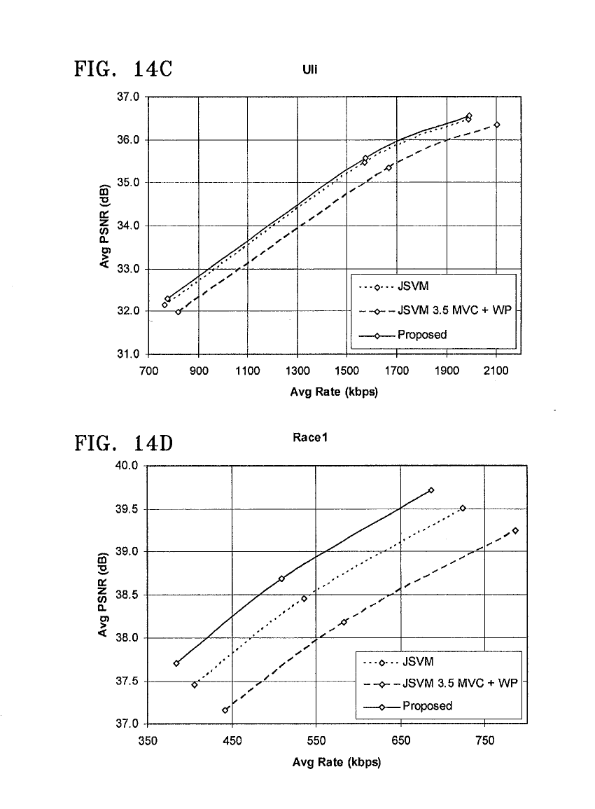

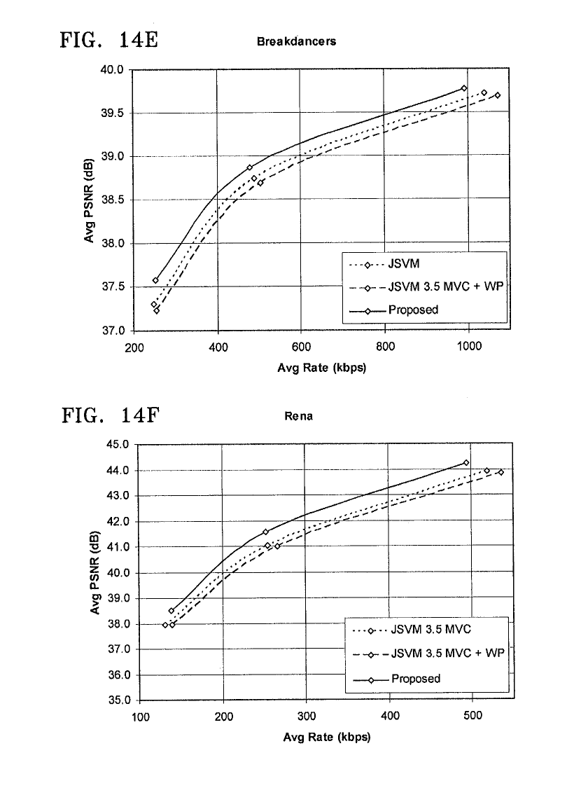

FIGS. 14A through 14F illustrate the effects of employing a method of encoding and decoding a signal by illumination compensated motion estimation according to an embodiment of the present invention.

As illustrated in FIGS. 14A through 14F, the method according to the present invention can achieve performance improvement of at least 0.1 dB up to 0.5 dB.

The present invention can also be embodied as computer readable codes on a computer readable recording medium. The computer readable recording medium is any data storage device that can store data, which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

### INDUSTRIAL APPLICABILITY

1. An apparatus for encoding a signal by illumination change compensated motion estimation comprising:
an illumination change compensation unit performing compensation for an illumination change by performing a differential calculation between each pixel value of a current block and the mean pixel value of the current block, and a differential calculation between each pixel value of a reference block indicated by a motion vector of the current block and the mean pixel value of the reference block;
a residual signals generation unit generating residual signals by performing a differential calculation between the current block in which illumination change compensation is performed by the illumination change compensation unit, and the reference block corresponding to the motion vector and in which illumination change compensation is performed; and
an illumination change amount prediction unit, wherein the amount of illumination change is the difference between the mean pixel value of the current block and the mean pixel value of the reference block, setting the amount of illumination change of the illumination compensated neighboring blocks as an illumination change amount prediction value of the current block, and performing differential pulse code modulation (DPCM) based on the illumination change amount and illumination change amount prediction value of the current block.

2. The apparatus of claim 1, further comprising a residual signals processing unit performing discrete cosine transformation (DCT) and quantization on the residual signals.

3. The apparatus of claim 1, wherein in inter mode in which motion detection is performed, the motion vector is obtained from a reference block which has a smallest NewSAD, wherein NewSADs are the values of the sums of absolute differences (NewSAD) obtained by subtracting the amount of illumination change from the difference between the pixel value of the current block and the pixel value of the reference block.

4. The apparatus of claim 1, wherein direct mode in which the motion detection is not performed, the motion vector is obtained by a temporal or spatial prediction method.

5. The apparatus of claim 1, wherein the illumination change amount prediction value is set to the median-filtered value of the pixels of the three neighboring blocks when the three neighboring blocks has been performed illumination compensation.

6. The apparatus of claim 1, wherein the residual signal is obtained according to an equation,
NewR(i,j)={f(i,j)−Mcur(m,n)}−{r(i+x′,j+y′)−Mref(m+x′,n+y′)},
where NewR(i,j) denotes a residual signal, f(i,j) denotes a pixel value at coordinates (i,j) of the current block, r(i+x′,j+y′) denotes a pixel value of the reference block corresponding to the motion vector, (x′,y′) denotes a motion vector, Mcur(m,n) denotes the mean pixel value of the current block, Mref(m+x,n+y) denotes the mean pixel value of the reference block, and (m,n) denotes a position of the top left pixel of the current block.

7. The apparatus of claim 3, wherein the NewSAD is obtained according to an equation,
$$NewSAD ( x , y ) = {\sum }_{i = m}^{m + S - 1} {\sum }_{j = n}^{n + T - 1} \vert \{ f ( i , j ) - {M}_{cur} ( m , n ) \} - \{ r ( i + x , j + y ) - {M}_{ref} ( m + x , n + y ) \} \vert ,$$
where f(i,j) denotes a pixel value at coordinates (i,j) of the current block, r(i+x,j+y) denotes a pixel value at coordinates (i+x,j+y) of the reference block, (x,y) denotes a motion vector, Mcur(m,n) denotes the mean pixel value of the current block, Mref(m+x,n+y) denotes the mean pixel value of the reference block, (m,n) denotes a position of the top left pixel of the current block, and S and T denote the sizes of blocks, respectively, which are used in block matching.

8. The apparatus of claim 1, wherein in the illumination change amount prediction unit, the neighboring blocks have the same reference frame numbers as the reference frame number of the current block.

9. The apparatus of any one of claims 3 and 4, wherein the inter mode is applied to a P slice or a B slice, and the direct mode is applied to a B slice.

10. An apparatus for decoding a signal by illumination change compensated motion estimation, comprising:
a reception unit receiving a bitstream, including encoded residual signals of a current block, illumination change indication information indicating whether or not illumination change compensation is performed, and an illumination change prediction differential signal (DPCM_DVIC) encoded by performing a differential calculation between the amount of illumination change of the current block and an illumination change amount prediction value of the current block; and
a reconstruction unit, reconstructing the current block based on the encoded residual signals, the encoded illumination change prediction differential signal (DPCM_DVIC), and the motion vector of the current block, if the illumination change indication information indicates that illumination change compensation is performed.

11. The apparatus of claim 10, wherein the reconstruction unit comprises:
an illumination change amount prediction unit predicting the amount of illumination change of the current block based on the amount of illumination change in illumination compensated neighboring blocks; and
an illumination change compensation unit performing illumination change compensation based on the amount of illumination change of the current block obtained by adding the predicted amount of illumination change and the illumination change prediction differential signal.

12. The apparatus of claim 10, wherein the amount of illumination change is the difference between the mean pixel value of the current block and the mean pixel value of the reference block.

13. The apparatus of claim 10, wherein in the reconstruction unit, the encoded residual signals is a residual signal encoded after subtracting the amount of illumination change from the difference between the pixel value of the current block and the pixel value of the reference block corresponding to the motion vector of the current block.

14. The apparatus of claim 10, wherein in inter mode, the motion vector is obtained from a reference block which has a smallest value of NewSAD, wherein NewSADs are the values of the sums of absolute differences (NewSAD), each of which is the difference obtained by subtracting the amount of illumination change from the difference between each pixel value of the current block and each pixel value of the reference block.

15. The apparatus of claim 10, wherein in direct mode, in which motion detection is not performed, the motion vector is obtained by a temporal or spatial prediction method.

16. The apparatus of claim 10, wherein the NewSAD is obtained according to an equation,
$$NewSAD ( x , y ) = {\sum }_{i = m}^{m + S - 1} {\sum }_{j = n}^{n + T - 1} \vert \{ f ( i , j ) - {M}_{cur} ( m , n ) \} - \{ r ( i + x , j + y ) - {M}_{ref} ( m + x , n + y ) \} \vert ,$$
where f(i,j) denotes a pixel value at coordinates (i,j) of the current block, r(i+x,j+y) denotes a pixel value at coordinates (i+x,j+y) of the reference block, (x,y) denotes a motion vector, Mcur(m,n) denotes the mean pixel value of the current block, Mref(m+x,n+y) denotes the mean pixel value of the reference block, (m,n) denotes a position of the top left pixel of the current block, and S and T denote the sizes of blocks, respectively, which are used in block matching.

17. The apparatus of claim 10, wherein in the reconstruction unit, the encoded residual signals are obtained by encoding each residual signal obtained according to an equation,
NewR(i,j)={f(i,j)−Mcur(m,n)}−{r(i+x′,j+y′)−Mref(m+x′,n+y′)},
where NewR(i,j) denotes a residual signal, f(i,j) denotes a pixel value at coordinates (i,j) of the current block, r(i+x′,j+y′) denotes a pixel value of the reference block corresponding to the motion vector, (x′,y′) denotes a motion vector, Mcur(m,n) denotes the mean pixel value of the current block, Mref(m+x,n+y) denotes the mean pixel value of the reference block, and (m,n) denotes the position of a top left pixel of the current block.

18. The apparatus of claim 10, wherein in the reconstruction unit, the current block is obtained according to an equation,
f′(i,j)={NewR″(i,j)+r(i+x′,j+y′)}+{Mcur(m.n)−Mref(m+x′,n+y′)},
where f′(i,j) denotes a pixel value at coordinates (i,j) of the current block, r(i+x′,j+y′) denotes a pixel value at coordinates (i+x′,j+y′) of the reference block, Mcur(m,n) denotes the mean pixel value of the current block, Mref(m+x′,n+y′) denotes the mean pixel value of the reference block, and (x,y) denotes a motion vector.

19. The apparatus of claim 10, wherein the illumination-compensated neighboring block has the same reference frame number as the reference frame number of the current block.

20. The apparatus of claim 14, wherein the inter mode is applied to a P slice or a B slice.

21. The apparatus of claim 15, wherein the direct mode is applied to a B slice.

22. A method of encoding a signal by illumination change compensated motion estimation comprising:
performing compensation for an illumination change by performing a differential calculation between each pixel value of a current block and the mean pixel value of the current block, and a differential calculation between each pixel value of a reference block indicated by a motion vector of the current block and the mean pixel value of the reference block;
generating residual signals by performing a differential calculation between the current block in which illumination change compensation is performed, and the reference block corresponding to the motion vector and in which illumination change compensation is performed; and
setting an amount of illumination change of the illumination-compensated neighboring block, as an illumination change amount prediction value of the current block and performing differential pulse code modulation (DPCM) based on the illumination change amount and illumination change amount prediction value of the current block, wherein the amount of illumination change is the difference between the mean pixel value of the current block and the mean pixel value of the reference block.

23. The method of claim 22, further comprising performing discrete cosine transformation (DCT) and quantization on the residual signals.

24. The method of claim 22, wherein in inter mode in which motion detection is performed, the motion vector is obtained from a reference block which has a smallest NewSAD, wherein NewSADs are the values of the sums of absolute differences (NewSAD), each of which is the difference obtained by subtracting the amount of illumination change from the difference between the pixel value of the current block and the pixel value of the reference block.

25. The method of claim 22, wherein in direct mode, in which motion detection is not performed, the motion vector is obtained by a temporal or spatial prediction method.

26. The method of claim 22, wherein when the three neighboring blocks has been performed illumination compensation, the illumination change amount prediction value is set to the median-filtered value of the pixels of the three neighboring blocks.

27. The method of claim 22, wherein the residual signal is obtained according to an equation,
NewR(i,j)={f(i,j)−Mcur(m,n)}−{r(i+x′,j+y′)−Mref(m+x′,n+y′)},
where NewR(i,j) denotes a residual signal, f(i,j) denotes a pixel value at coordinates (i,j) of the current block, r(i+x′,j+y′) denotes a pixel value of the reference block corresponding to the motion vector, (x′,y′) denotes a motion vector, Mcur(m,n) denotes the mean pixel value of the current block, Mref(m+x,n+y) denotes the mean pixel value of the reference block, and (m,n) denotes a position of the top left pixel of the current block.

28. The method of claim 24, wherein the NewSAD is obtained according to an equation,
$$NewSAD ( x , y ) = {\sum }_{i = m}^{m + S - 1} {\sum }_{j = n}^{n + T - 1} \vert \{ f ( i , j ) - {M}_{cur} ( m , n ) \} - \{ r ( i + x , j + y ) - {M}_{ref} ( m + x , n + y ) \} \vert ,$$
where f(i,j) denotes a pixel value at coordinates (i,j) of the current block, r(i+x,j+y) denotes a pixel value at coordinates (i+x,j+y) of the reference block, (x,y) denotes a motion vector, Mcur(m,n) denotes the mean pixel value of the current block, Mref(m+x,n+y) denotes the mean pixel value of the reference block, (m,n) denotes a position of the top left pixel of the current block, and S and T denote the sizes of blocks, respectively, which are used in block matching.

29. The method of claim 22, wherein in the prediction of the amount of illumination change, the neighboring blocks have the same reference frame number as the reference frame number of the current block.

30. The method of any one of claims 24 and 25, wherein the inter mode is applied to a P slice or a B slice, and the direct mode is applied to a B slice.

31. A method of encoding a signal by illumination change compensated motion estimation in inter mode in which motion detection is performed, the method comprising:
setting a motion vector based on a value (NewSAD) which is the sum of absolute differences each of which is the difference obtained by subtracting the amount of illumination change which is the difference between the mean pixel value of a current block and the mean pixel value of a reference block from the difference between a pixel value of the current block and a pixel value of the reference block;
performing compensation for an illumination change by performing a differential calculation between each pixel value of the current block and the mean pixel value of the current block, and a differential calculation between each pixel value of the reference block indicated by the motion vector and the mean pixel value of the reference block; and
setting the amount of illumination change of the illumination compensated neighboring blocks, as an illumination change amount prediction value of the current block, and performing differential pulse code modulation (DPCM) based on the illumination change amount and illumination change amount prediction value of the current block.

32. The method of claim 31, wherein the performing of the compensation for the illumination change comprises:
generating residual signals by performing a differential calculation between the illumination-compensated current block, and the illumination-compensated reference block corresponding to the motion vector; and
processing the residual signals by performing discrete cosine transformation (DCT) and quantization on the residual signals.

33. The method of claim 31, wherein the NewSAD is obtained according to an equation,
$$NewSAD ( x , y ) = {\sum }_{i = m}^{m + S - 1} {\sum }_{j = n}^{n + T - 1} \vert \{ f ( i , j ) - {M}_{cur} ( m , n ) \} - \{ r ( i + x , j + y ) - {M}_{ref} ( m + x , n + y ) \} \vert ,$$
where f(i,j) denotes a pixel value at coordinates (i,j) of the current block, r(i+x,j+y) denotes a pixel value at coordinates (i+x,j+y) of the reference block, (x,y) denotes a motion vector, Mcur(m,n) denotes the mean pixel value of the current block, Mref(m+x,n+y) denotes the mean pixel value of the reference block, (m,n) denotes the position of a top left pixel of the current block, and S and T denote the sizes of blocks, respectively, which are used in block matching.

34. The method of claim 32, wherein each residual signal is obtained according to an equation,
NewR(i,j)={f(i,j)−Mcur(m,n)}−{r(i+x′,j+y′)−Mref(m+x′,n+y′)},
where NewR(i,j) denotes a residual signal, f(i,j) denotes a pixel value at coordinates (i,j) of the current block, r(i+x′,j+y′) denotes a pixel value of the reference block corresponding to the motion vector, (x′,y′) denotes a motion vector, Mcur(m,n) denotes the mean pixel value of the current block, Mref(m+x,n+y) denotes the mean pixel value of the reference block, and (m,n) denotes a position of the top left pixel of the current block.

35. The method of claim 31, wherein the illumination change amount prediction value is set to the median-filtered value of the pixels of the three neighboring blocks when the three neighboring blocks has been performed illumination compensation.

36. The method of claim 31, wherein the inter mode is applied to a P slice or a B slice.

37. A method of encoding a signal by illumination change compensated motion estimation in direct mode in which motion detection is not performed, the method comprising:
performing compensation for an illumination change by performing a differential calculation between each pixel value of a current block and the mean pixel value of the current block, and a differential calculation between each pixel value of a reference block indicated by a motion vector obtained by a temporal or spatial prediction method, and the mean pixel value of the reference block; and
setting the amount of illumination change of the illumination-compensated neighboring block, as an illumination change amount prediction value of the current block and performing differential pulse code modulation (DPCM) based on the illumination change amount and illumination change amount prediction value of the current block, wherein the amount of illumination change is the difference between the mean pixel value of the current block and the mean pixel value of the reference block.

38. The method of claim 37, wherein the performing of the compensation for the illumination change comprises:
generating residual signals, by performing a differential calculation between the illumination-compensated current block, and the illumination-compensated reference block corresponding to the motion vector; and
processing the residual signals by performing discrete cosine transformation (DCT) and quantization on the residual signals.

39. The method of claim 38, wherein each residual signal is obtained according to an equation,
NewR(i,j)={f(i,j)−Mcur(m,n)}−{r(i+x′,j+y′)−Mref(m+x′,n+y′)},
where NewR(i,j) denotes a residual signal, f(i,j) denotes a pixel value at coordinates (i,j) of the current block, r(i+x′,j+y′) denotes a pixel value of the reference block corresponding to the motion vector, (x′,y′) denotes a motion vector, Mcur(m,n) denotes the mean pixel value of the current block, Mref(m+x,n+y) denotes the mean pixel value of the reference block, and (m,n) denotes a position of the top left pixel of the current block.

40. The method of claim 37, when the three neighboring blocks has been performed illumination compensation, the illumination change amount prediction value is set to the median-filtered value of the pixels of the three neighboring blocks.

41. The method of claim 37, wherein the direct mode is applied to a B slice.

42. A method of decoding a signal by illumination change compensated motion estimation, comprising:
receiving a bitstream, including the encoded residual signals of a current block, illumination change indication information indicating whether or not illumination change compensation is performed, and an illumination change prediction differential signal (DPCM_DVIC) encoded by performing a differential calculation between the amount of illumination change of the current block and an illumination change amount prediction value of the current block; and
if the illumination change indication information indicates that illumination change compensation has been performed, reconstructing the current block based on the encoded residual signals, the encoded illumination change prediction differential signal (DPCM_DVIC), and the motion vector of the current block.

43. The method of claim 42, wherein the reconstructing of the current block comprises:
predicting the amount of illumination change of the current block based on the amount of illumination change in illumination compensated neighboring blocks;
calculating the amount of illumination change of the current block by adding the predicted amount of illumination change and the illumination change prediction differential signal; and
performing illumination change compensation based on the calculated amount of illumination change.

44. The method of claim 43, wherein in the inter-mode, the motion vector is obtained from a reference block which has a smallest value of NewSAD, wherein NewSADs are the values of the sums of absolute differences (NewSAD), each of which is the difference obtained by subtracting the amount of illumination change from the difference between the pixel value of the current block and the pixel value of the reference block.

45. The method of claim 44, wherein in direct mode, in which motion detection is not performed, the motion vector is obtained by a temporal or spatial prediction method.

46. The method of claim 44, wherein the NewSAD is obtained according to an equation,
$$NewSAD ( x , y ) = {\sum }_{i = m}^{m + S - 1} {\sum }_{j = n}^{n + T - 1} \vert \{ f ( i , j ) - {M}_{cur} ( m , n ) \} - \{ r ( i + x , j + y ) - {M}_{ref} ( m + x , n + y ) \} \vert ,$$
where f(i,j) denotes a pixel value at coordinates (i,j) of the current block, r(i+x,j+y) denotes a pixel value at coordinates (i+x,j+y) of the reference block, (x,y) denotes a motion vector, Mcur(m,n) denotes the mean pixel value of the current block, Mref(m+x,n+y) denotes the mean pixel value of the reference block, (m,n) denotes a position of the top left pixel of the current block, and S and T denote the sizes of blocks, respectively, which are used in block matching.

47. The method of claim 43, wherein the encoded residual signals are obtained by encoding each residual signal obtained according to an equation,
NewR(i,j)={f(i,j)−Mcur(m,n)}−{r(i+x′,j+y′)−Mref(m+x′,n+y′)},
where NewR(i,j) denotes a residual signal, f(i,j) denotes a pixel value at coordinates (i,j) of the current block, r(i+x′,j+y′) denotes a pixel value of the reference block corresponding to the motion vector, (x′,y′) denotes a motion vector, Mcur(m,n) denotes the mean pixel value of the current block, Mref(m+x,n+y) denotes the mean pixel value of the reference block, and (m,n) denotes a position of the top left pixel of the current block.

48. The method of claim 43, wherein in the restoring, the current block is obtained according to an equation,
f′(i,j)={NewR″(i,j)+r(i+x′,j+y′)}+{Mcur(m.n)−Mref(m+x′,n+y′)},
where f′(i,j) denotes a pixel value at coordinates (i,j) of the current block, r(i+x′,j+y′) denotes a pixel value at coordinates (i+x′,j+y′) of the reference block, Mcur(m,n) denotes the mean pixel value of the current block, Mref(m+x′,n+y′) denotes the mean pixel value of the reference block, and (x,y) denotes a motion vector.

49. The method of claim 43, wherein the neighboring block in which illumination change compensation has been performed, has the same reference frame number as the reference frame number of the current block.

50. The method of claim 44, wherein the inter mode is applied to a P slice or a B slice.

51. The method of claim 55, wherein the direct mode is applied to a B slice.
